(19) United States
(12) Patent Application Publication
(10) Pub. No.: US 2008/0250645 A1
(43) Pub. Date: Oct. 16, 2008

(54) Hair Clipper with Light Source

(76) Inventors: Richard J. Tringali, Racine, WI (US); Robert E. Derby, Racine, WI (US); Jeff Gross, Kenosha, WI (US); Christopher J. Braun, Racine, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/088,191

(22) PCT Filed: Oct. 5, 2006
(86) PCT No.: PCT/US06/38972

§ 371 Date: Mar. 26, 2008

Related U.S. Application Data
(60) Provisional application No. 60/723,992, filed on Oct. 6, 2005.

(51) Int. Cl. B26B 19/00; B26B 19/28; B26B 21/40; B26B 19/46

(52) U.S. Cl. 30/34.05; 30/45; 30/537; 362/115

(57) ABSTRACT

A hair clipper includes a housing that defines a cavity and has an opening communicating with the cavity. The hair clipper further includes a blade assembly coupled to a cutting end of the housing and a holder positioned within the cavity and proximate the opening. The hair clipper further includes a plurality of light sources, wherein each light source is received by the holder. The light sources are positioned to direct light through the opening and towards the cutting end of the housing.

### CROSS REFERENCE TO RELATED APPLICATION

This application claims priority from U.S. Provisional Patent Application No. 60/723,992, entitled “Hair Clipper with Light Source,” filed Oct. 6, 2005 by Richard J. Tringali, Robert E. Derby and Jeff Gross.

### BACKGROUND

The present invention relates to an apparatus for trimming hair, and in particular, a hair clipper with a light source.

Trimming the hair of a person or animal, in particular a large animal, in a dimly lit area poses a variety of difficulties, including locating and identifying cutting blades, a work area, and hair strands to be cut. Light bulbs and other external illumination methods are frequently inadequate for proper work area visualization. Insufficient illumination of the cutting blades and work area is a burden to the hair clipper operator. When the cutting blades, work area and even the hair being cut are insufficiently illuminated, cutting errors are prevalent.

These illumination devices also require frequent replacement of the illuminating device because standard clipper circuitry does not promote long life of the illumination device. Maintenance and access to the clipper are further limited by clipper housing designs providing for burdensome interior access.

### SUMMARY

In one embodiment, the present invention provides a hair clipper including a housing defining a cavity and including an opening communicating with the cavity. A blade assembly is coupled to a cutting end of the housing. A holder is positioned within the cavity and proximate the opening. Each light source is received by the holder, and the light sources are positioned to direct light through the opening and towards the cutting end of the housing.

In another embodiment, the present invention provides a hair clipper including a housing defining a cavity and having a cutting end. A drive cap is coupled to the housing adjacent the cutting end, the drive cap further defining the cavity and including an opening communicating with the cavity. A blade assembly is coupled to the cutting end of the housing. A holder is positioned within the cavity and proximate the opening. Each light source is received by the holder with the lights sources positioned to direct light through the opening and towards the cutting end of the housing.

In another embodiment, the present invention provides a hair clipper including a housing having a lower portion and an upper portion. The housing defines a cavity and the upper portion includes an opening communicating with the cavity. A blade assembly is coupled to a cutting end of the housing. A holder is positioned within the cavity and proximate the opening. Each light source is received by the holder with the lights sources positioned to direct light through the opening and towards the cutting end of the housing. A circuit board is electrically coupled to a power source and the light sources.

Other aspects of the invention will become apparent by consideration of the detailed description and accompanying drawings.

### BRIEF DESCRIPTION OF THE DRAWINGS

FIG. 1 is a perspective view of a hair clipper according to one embodiment of the invention.

FIG. 2. is an exploded view of the hair clipper of FIG. 1.

FIG. 3 is a sectional view of an upper housing portion of the hair clipper.

FIG. 4A is a front view of a light source holder of the hair clipper.

FIG. 4B is a front perspective view of the light source holder of FIG. 4A, including light sources.

FIG. 5A is front perspective view of a drive cap of the hair clipper.

FIG. 5B is a sectional, exploded view of the drive cap of FIG. 5A along section line 5B-5B.

FIG. 6 is a schematic diagram of electric circuitry and internal wiring for one embodiment of the hair clipper.

FIG. 7 is a schematic of the circuit diagram for the hair clipper shown in FIG. 6.

FIG. 8 is an exploded view of a hair clipper according to another embodiment of the invention.

FIG. 9 is a bottom perspective view of the upper housing portion of the hair clipper shown in FIG. 8.

FIG. 10 is a perspective view of a hair clipper according to another embodiment of the invention.

FIG. 11 is a perspective view of the hair clipper shown in FIG. 10 with an upper housing portion removed to reveal a light source holder.

FIG. 12 is a perspective view of the light source holder shown in FIG. 11.

FIG. 13 is a front perspective view of a hair clipper according to another embodiment of the invention.

FIG. 14 is a front perspective view of the hair clipper shown in FIG. 13 with an upper housing portion removed to reveal a light source and a light source holder.

FIG. 15 is a rear perspective view of the hair clipper shown in FIG. 13 with an upper housing portion and circuit board removed.

FIG. 16 is a perspective view of the light source holder shown in FIGS. 14 and 15.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

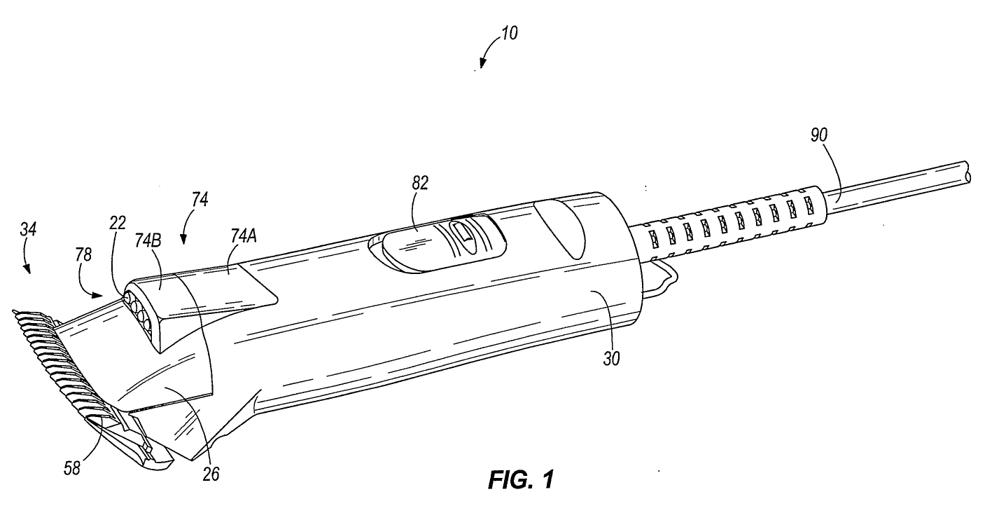

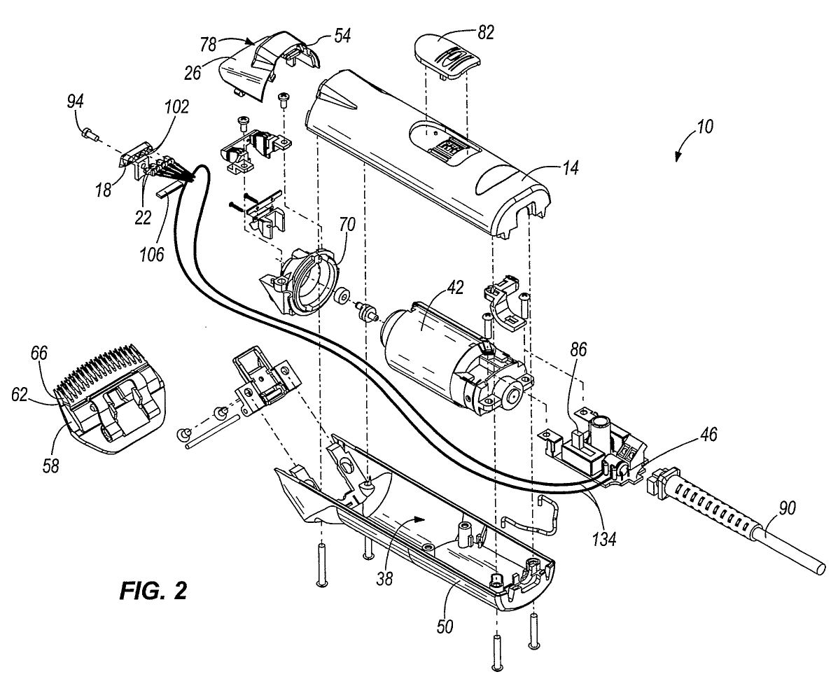

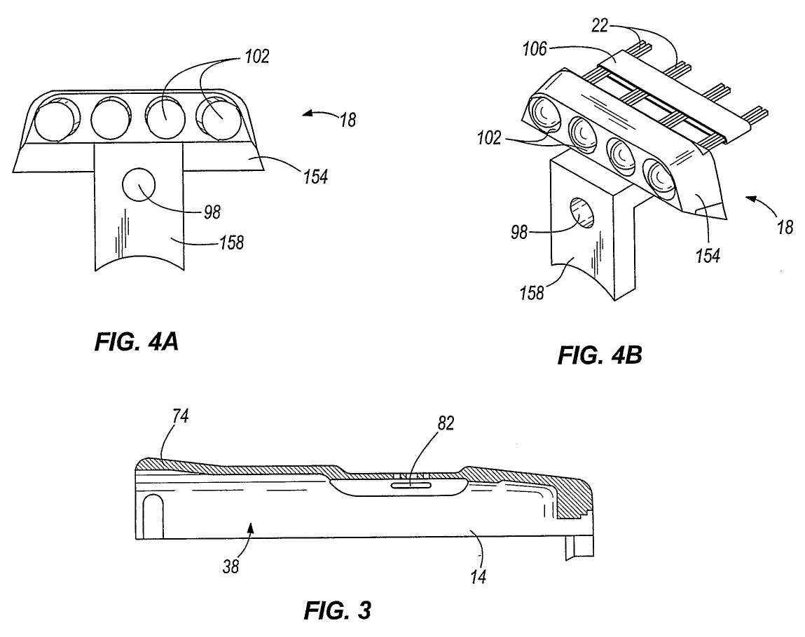

FIGS. 1 and 2 illustrate a hair clipper 10 and hair clipper components according to one embodiment of the present invention. FIGS. 3-5 illustrate more detailed views of the clipper 10 and clipper components, including an upper housing portion 14, a light source holder 18, light sources 22 and a drive cap 26. It should be readily evident to one of ordinary skill in the art that the present invention may also be utilized in a hair trimmer.

The hair clipper 10 includes a hollow, elongated housing 30 having a cutting end 34 and defining an inner cavity 38 (also shown in FIG. 3). The inner cavity 38 substantially houses and surrounds various clipper components, including, but not limited to, the light source holder 18, light sources 22, a motor mechanism 42, a circuit board 46, and the like. The housing 30 includes the upper housing portion 14, a lower housing portion 50, and the drive cap 26 positioned at the cutting end 34.

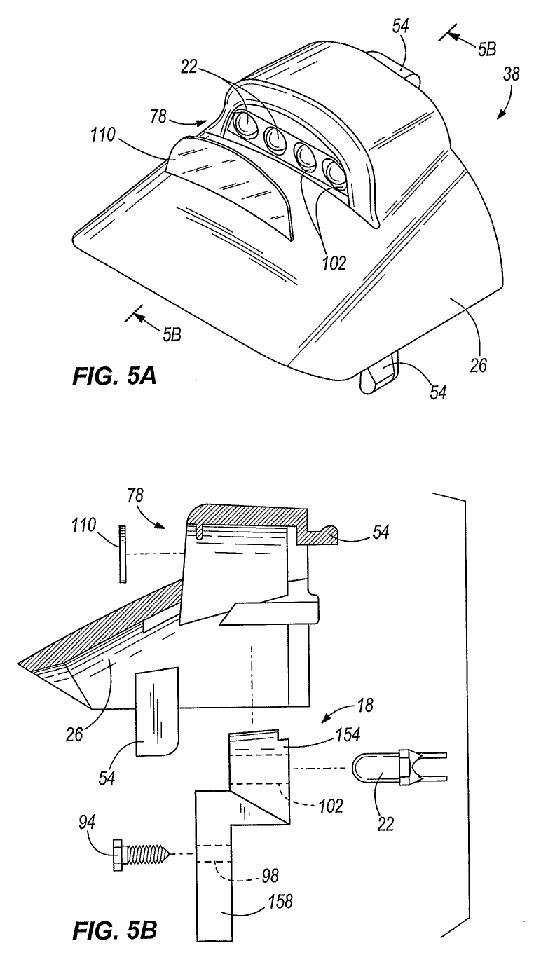

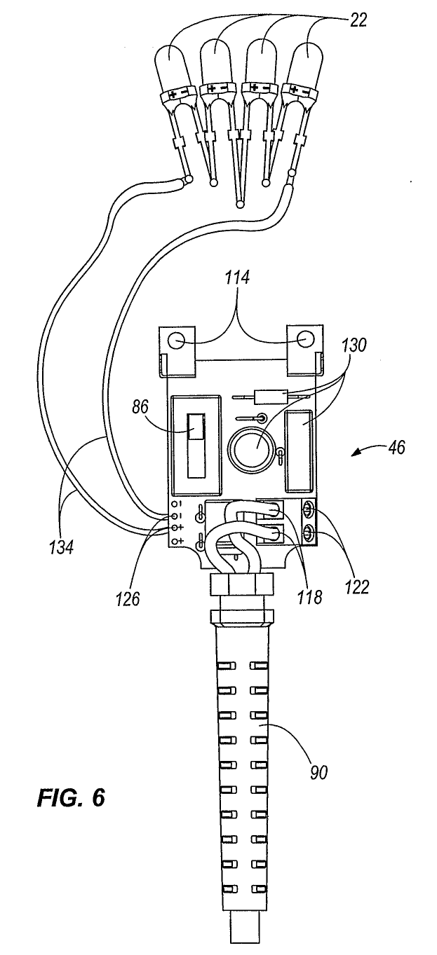

The drive cap 26 is removably coupled to the upper housing portion 14. The removable drive cap 26 allows easy access to the inner cavity 38 of the clipper 10. Referring to FIGS. 2, 5A and 5B, biased tabs 54 couple the drive cap 26 to the housing 30. It should be readily apparent to one of skill in the art that the drive cap 26 may be coupled and removed in a number of ways, including, but not limited to, a snap and lock mechanism or other fastening device or method. In a further embodiment, the upper housing portion 14 may comprise a one-piece portion where the drive cap 26 is integral with or formed from a single piece of the upper housing portion 14.

The upper housing portion 14 and the drive cap 26 define a shroud 74 having an opening 78 for communicating with the inner cavity 38. A first portion of the shroud 74A is formed by the upper housing portion 14, and a second portion of the shroud 74B is formed by the drive cap 26. The opening 78 is positioned on the drive cap portion of the shroud 74B and opens towards the cutting end, thereby allowing light from the light sources 22 supported by the light source holder 18 to pass through the opening 78 and towards a blade assembly 58.

As illustrated in FIG. 1, the blade assembly 58 is coupled to the cutting end 34 of the housing 30. The blade assembly 58 includes a fixed blade 62 mounted to the housing 30 and a reciprocating blade 66 biased against and movable with respect to the fixed blade 62 by a motor mechanism 42 (FIG. 2), as is known in the art. The motor mechanism 42, in combination with electrical power, drives the blade assembly 58. As the hair clipper 10 is guided through the person or animal's hair, the reciprocating motion of the blade assembly 58 cuts the hair. Referring to FIG. 2, the motor mechanism 42 is received and supported by a motor frame 70, which is substantially located in the inner cavity 38 and coupled to the housing 30.

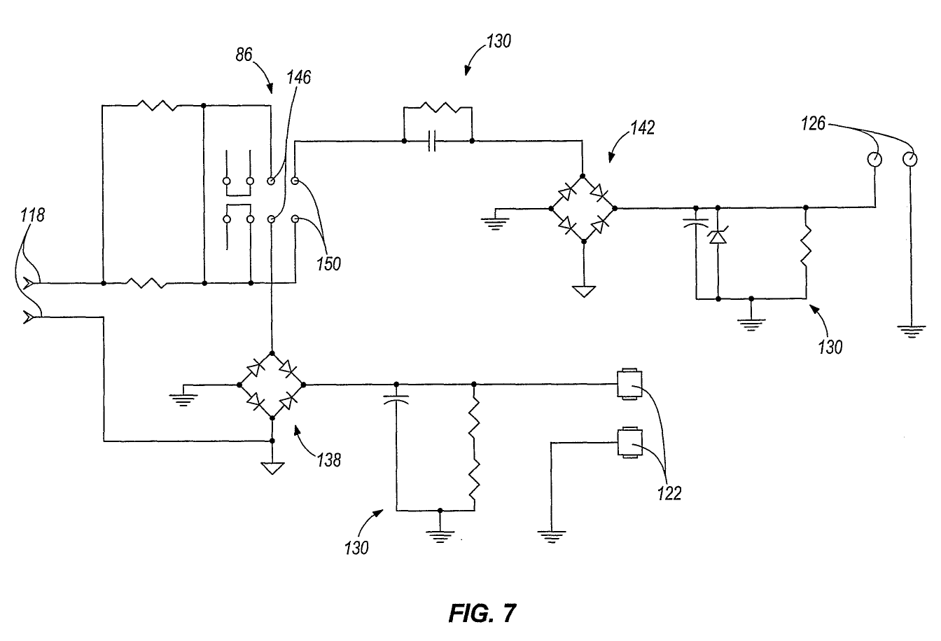

The housing 30 includes a power switch 82 positioned in the upper housing portion 14 and electrically coupled to an electrical switch 86 (discussed below with respect to FIGS. 6 and 7) on the circuit board 46 to activate the motor mechanism 42 upon manual actuation by a user. An electrical connector 90 extends from an end of the housing 30 and is electrically connected to an external power source and other circuitry to provide a source of electrical power to the hair clipper 10. In a further embodiment, the electrical power includes an alternating current (AC) power provided via a corded plug electrically coupled to a wall outlet and/or a direct current (DC) power provided by a battery (e.g., a rechargeable battery disposed in the cavity). Hair clippers powered by AC and/or DC power are generally known in the art and, accordingly, are not discussed further herein.

A number of suitable blade sets, motors, and driving arrangements are known. It should be appreciated that hair clippers having other types of blade sets, motors and/or driving arrangements would be suitable for use in combination with the present invention.

With reference to FIGS. 4A-5B, the clipper 10 includes the light source holder 18 substantially housed in the drive cap 26 and positioned within the inner cavity 38 and proximate the opening 78 formed in the drive cap 26. The light source holder 18 includes a body portion 154 and a mounting portion 158 extending substantially perpendicular to the body portion 154. Four apertures 102 are formed in the body portion 154 for receiving the light sources 22. Each aperture 102 slidingly receives one of the light sources 22. In a further embodiment, the apertures 102 may receive the light sources 22 through a screw motion and the like. In the illustrated embodiment, the light source holder 18 is coupled to the upper housing portion 14 (FIG. 2) with a fastener 94 received in a fastening aperture 98 formed in the mounting portion 158. The fastener 94 may be a screw, nail, clip or similar fastening apparatus. The fastener aperture 98 receives the fastener 94 to couple the light source holder 18 to the upper housing portion 14. In some embodiments, the light source holder may be coupled to the drive cap 26. In the illustrated embodiment, the apertures 102 are circular, but in a further embodiment, the apertures 102 may be other shapes, for example, square. Further, the light source holder 18 may include fewer or more apertures 102 corresponding to the number of light sources 22.

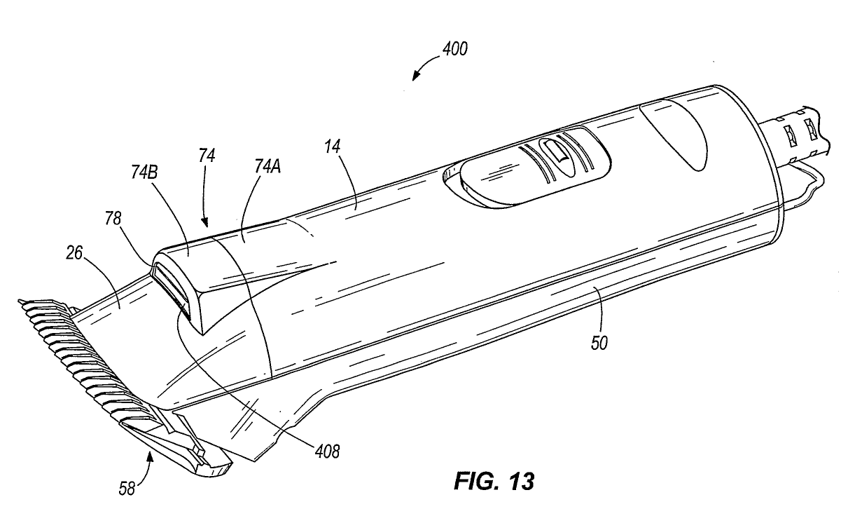

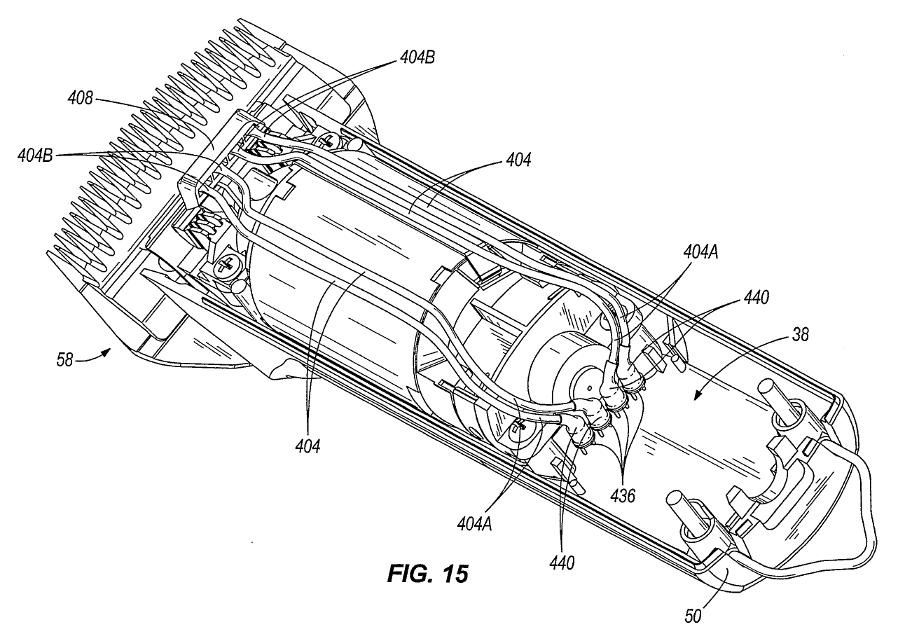

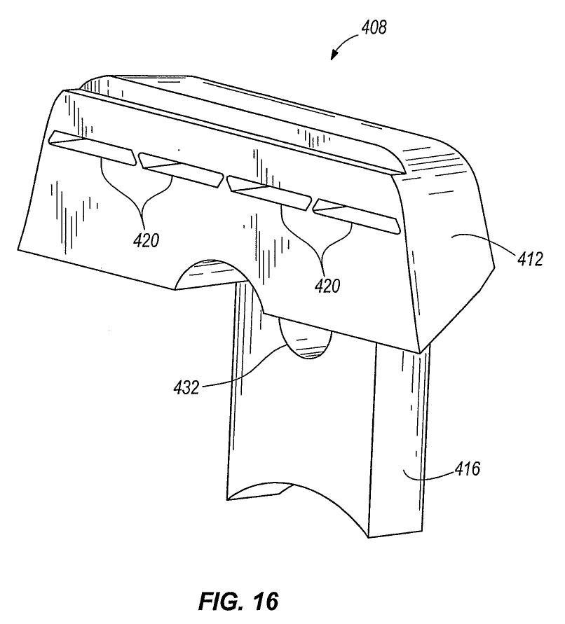

In the illustrated embodiment, the light sources 22 are light-emitting diodes (LEDs) that emit white light, although any number of light colors may be used. The apertures 102 direct the light sources 22 toward the opening 78 at the cutting end 34 of the housing 30 and are further positioned within the drive cap 26 to direct light through the opening 78 in the drive cap 26. The light from the light sources 22 is directed to the blade assembly 58 to illuminate the hair being cut, the blade assembly 58, and work area adjacent to the hair being cut. In the illustrated embodiment, the apertures 102 in the light source holder 18 are in a linear arrangement. In a further embodiment, the apertures 102 may be in a non-linear arrangement, wherein one aperture 102 may be in a more forward position than an adjacent aperture 102. The apertures 102 may also be at various angles within the light source holder 18 so that the light sources 22 are directed at various angles. The linearity, angularity and numerical arrangement of the apertures 102 may be based on the hair clipping application for which the hair clipper 10 is utilized. In a further embodiment, other light sources may be used, such as fiber optics (discussed below with respect to FIGS. 13-16), light bulbs, light tubes, or the like.

As shown in FIGS. 2 and 4B, foam tape 106 is used as a protective means to anchor the light sources 22 relative to the drive cap 26 and the light source holder 18. The foam tape 106 also keeps the light sources 22 directed toward the opening 78 of the drive cap 26. In the illustrated embodiment, the foam tape 106 wraps around wires that extend from the light sources 22. In a further embodiment, the foam tape 106 may anchor the light sources 22 to the upper housing portion 14 so that the light sources 22 do not become dislodged from the apertures 102. The foam tape 106 may further protect the light sources 22 from damage or dislodging if the clipper 10 is dropped. The foam tape 106 may be constructed of a plurality of materials, including, but not limited to foam or other cushion type material and the like. It should be readily apparent to those of skill in the art that the foam tape may be replaced by other protective means, such as, but not limited to foam cushion, rubber cement and the like to anchor the light sources 22 relative to the drive cap 26 and the light source holder 18.

The clipper 10 can be utilized with or without a lens 110. As shown in FIGS. 5A and 5B, if used, the lens 110 is generally positioned within the opening 78 in the drive cap 26. The lens 110 is coupled to the drive cap 26 by way of a snap and lock mechanism, a heat stake application, adhesive, tape, screws, rivets, snaps, or like fastening mechanisms. The lens 110 may be a glass, plastic, or other similar material that permits the unobscured passage of light. The lens 110 protects the inner cavity 38 of the housing 30 from the penetration of physical objects through the opening 78, as well as prevents hair from infiltrating the inner cavity 38 of the housing 30. If a lens 110 is not utilized, the opening 78 allows the interior of the clipper 10 to be open and accessible to the user, thereby allowing for easy cleaning and access around the lights sources 22 and into the interior of the clipper 10.

FIG. 6 illustrates a schematic of an electric circuitry and internal wiring used to provide power to the light sources 22 in one embodiment of the clipper 10. The circuit board 46 is a constant current, soft start, voltage limited circuit board 46. The circuit board 46 includes attachment apertures 114, power terminals 118, motor terminals 122, light source terminals 126, the electrical switch 86, and a plurality of electronic components 130. The circuit board 46 also supplies the motor mechanism 42 with power, as described in greater detail below.

The circuit board 46 is connected to the lower housing portion 50 (FIG. 2) via the attachment apertures 114 by fasteners (not shown). In one embodiment, screws are used to secure the circuit board 46 to the housing 30; however, any suitable fastener can be used. The power terminals 118 connect the circuit board 46 to the electrical connector 90, or other power source. As previously described, the power source is generally a 120 volt alternating current (“AC”) source. In the illustrated embodiment, power from the power terminals 118 is distributed to all of the components on the circuit board 46. As a result, separate circuit boards are not needed for relatively higher power components (e.g., the motor mechanism 42) and relatively lower power components (e.g., the light sources 22). In the illustrated embodiment, the motor terminals 122 provide power to the motor mechanism 42, while the light source terminals 126 provide power to the light sources 22 via wires 134.

In operation, a user actuates the motor mechanism 42 by manipulating the power switch 82 (FIG. 1) provided on the housing 30 of the hair clipper 10. The power switch 82 is coupled to the electrical switch 86 such that manipulation of the power switch 82 will cause a corresponding manipulation of the electrical switch 86. The electrical switch 86 is configured to interrupt the flow of electrical power from a power supply to the motor mechanism 42. The electrical switch 86 is a three position switch that is operable to control whether power is supplied from the power terminals 118 to the motor terminals 122 and light source terminals 126, as described in greater detail with respect to FIG. 7. For example, when the electrical switch 86 is positioned in a first position, power is not supplied to either of the terminals 122 and 126. When the electrical switch 86 is moved from the first position to a second position, power is supplied to the motor terminals 122 only. Moving the electrical switch 86 from the second position to the third position, then, supplies power to both the motor terminals 122 and the light source terminals 126. Providing a three position electrical switch 86 allows the user to choose whether or not to use the light sources 22 while operating the clipper 10. However, in a further embodiment, a two position electrical switch may be used, requiring the motor mechanism 42 and the light sources 22 to be powered at the same time. The plurality of electronic components 130 are used to condition the power supply, as described in greater detail with respect to FIG. 7.

FIG. 7 is a schematic of the circuit diagram of the circuit board 46. The schematic generally depicts the power terminals 118, the motor terminals 122, the light source terminals 126, the electrical switch 86, a motor rectifier 138, and a light source rectifier 142. In a further embodiment, more or fewer electronics may be implemented than those shown in FIG. 7.

As previously described, current is supplied to the power terminals 118 via the electrical connector 90. The current from the power terminals 118 is routed to the electrical switch 86. The electrical switch 86 includes a first set of terminals 146 and a second set of terminals 150. Advancing the electrical switch 86 from an “OFF” position (i.e., the first position) to the first set of terminals 146 (i.e., the second position) allows current to flow through the motor rectifier 138 and to the motor terminals 122. Advancing the electrical switch 126 from the first set of terminals 146 to the second set of terminals 150 (i.e., the third position) allows current to flow through the light source rectifier 142 and to the light source terminals 126. As a result, as previously described, the user can choose whether to run the motor mechanism 42 with, or without, the light sources 22. The light source rectifier 142 prohibits reverse voltage within the circuitry, thereby enabling long life for the light sources 22. The remainder of the electronic components 130 (e.g., capacitors, resistors, diodes, etc.) are included to provide the proper power supply to the motor mechanism 42 and light source 22, including operations such as removing all circuit voltage when the light sources 22 are switched off, creating a constant current source, creating a soft start, providing a voltage limit, and the like. Such electronic components 130 and their operations are not specifically described herein.

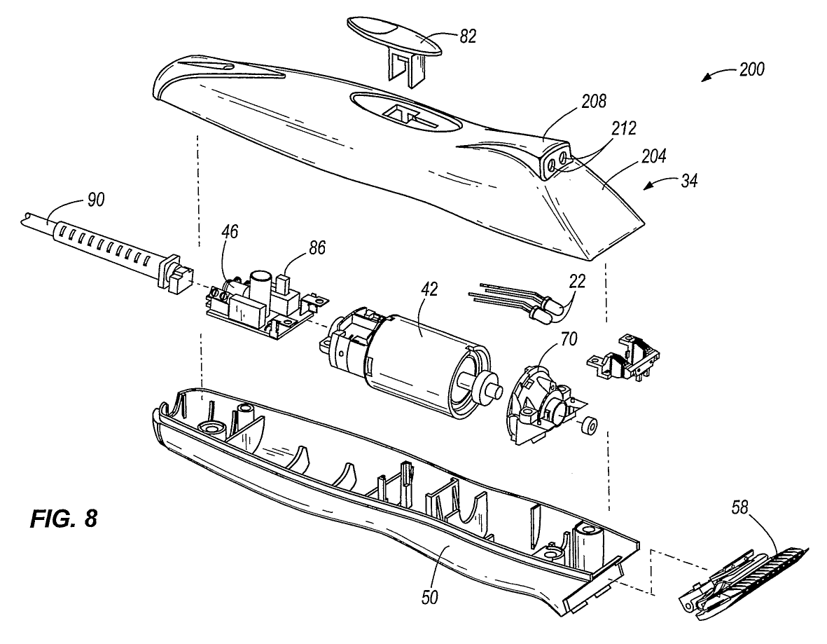

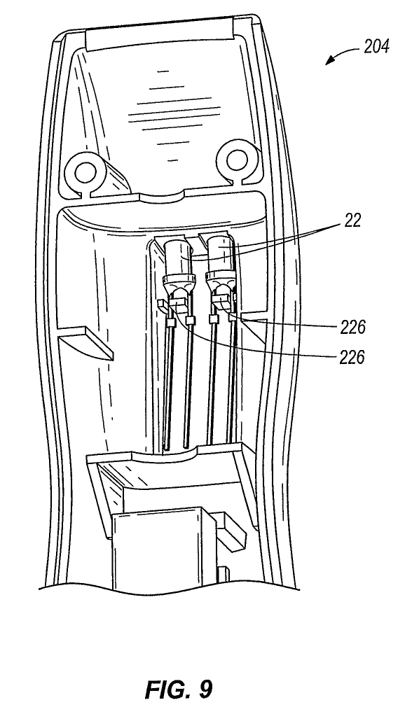

FIGS. 8 and 9 illustrate another embodiment of a hair clipper 200. Like elements of the hair clipper 10 shown in FIG. 1 are identified by the same reference numerals. The hair clipper 200 includes an upper housing portion 204, wherein the drive cap is integrally formed as a single piece with the upper housing portion 204. A shroud portion 208 protrudes from the upper housing portion 204 and a plurality of apertures 212 are formed in the shroud portion 208. The shroud portion 208 is positioned adjacent the cutting end 34 of the upper housing portion 204 and the blade assembly 58, such that the apertures 212 are directed toward the cutting end 34. In the illustrated embodiment, the light source holder 226 comprises fastening brackets integrally formed in an inner surface of the upper housing portion 204 to provide a snap-fit hold for the light sources 22. In the illustrated embodiment, each light source 22 is coupled to the upper housing portion 204 and light is directed through one of the apertures 212 in the shroud portion 208. In other embodiments, the light source holders 226 may be adhesive, screws, or a like coupling mechanism. The upper housing portion 204 may have individual apertures 212 for the light sources 22; in other embodiments, the upper housing portion 14 may have one aperture for a plurality of light sources 22.

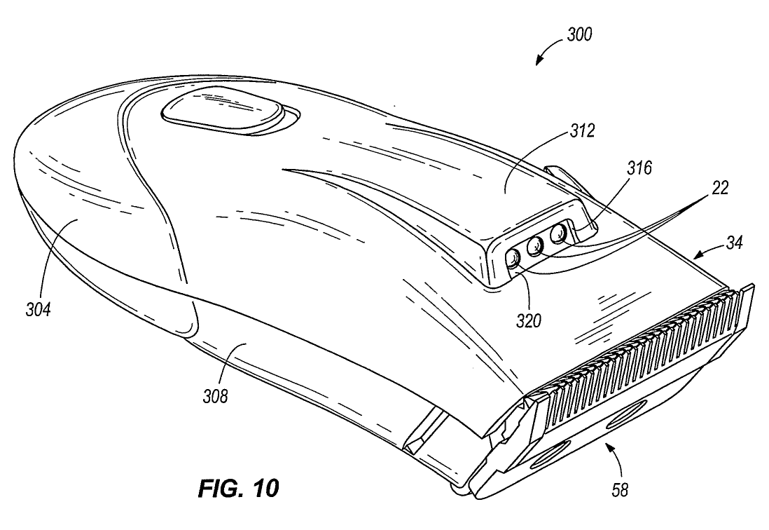

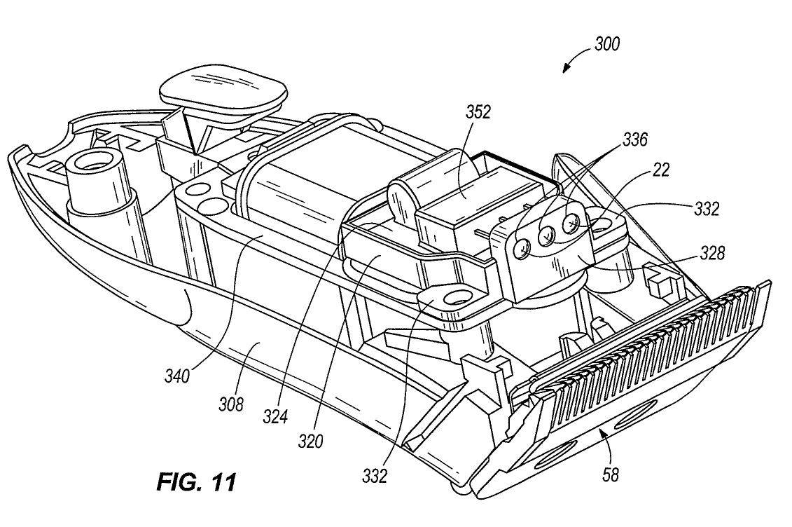

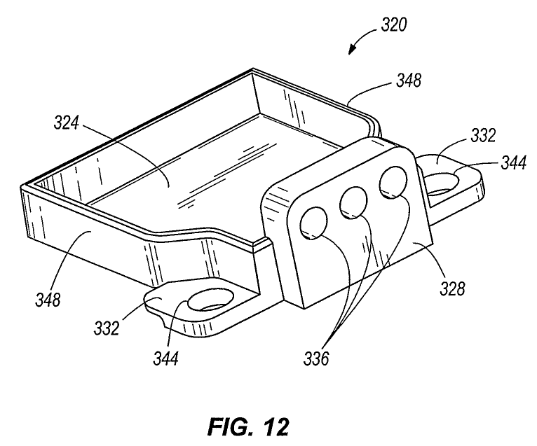

FIGS. 10 and 11 illustrate another embodiment of a hair clipper 300. Like elements of the hair clipper 10 shown in FIG. 1 are identified by the same reference numerals. The hair clipper 300 includes an upper housing portion 304 and a lower housing portion 308. A shroud portion 312 protrudes from the upper housing portion 304 and an opening 316 is formed in the shroud portion 312. The shroud portion 312 is positioned adjacent the cutting end 34 of the upper housing portion 304 and the blade assembly 58. The opening 316 is directed toward the cutting end 34, thereby allowing light from the light sources 22 supported by a light source holder 320 to pass through the opening 316 and towards the blade assembly 58. In another embodiment, the upper housing portion 304 is a two-piece design and includes a drive cap removably coupled to the upper housing portion 304 at the cutting end 34, similar to the drive cap 26 discussed above and shown in FIG. 1.

The light source holder 320 is substantially housed in the upper housing portion 304 and positioned within the inner cavity 38 proximate the opening 316. Referring to FIGS. 11 and 12, the light source holder 320 includes a tray 324 having a forward edge 328 and attachment flanges 332. The forward edge 328 of the tray 324 has a height greater than other edges of the tray 324. Three apertures 336 are formed in the forward edge 328 of the tray for receiving the light sources 22. Each aperture 336 slidingly receives one of the light sources 22, although in another embodiment, the apertures 336 may receive the light sources 22 through a screw-type motion or the like. In the illustrated embodiment, the apertures 336 are circular, although the apertures 336 may be of another shape (e.g., shape). Further, the forward edge 328 may include fewer or more apertures 336 corresponding to the number of light sources 22.

In the illustrated embodiment, the light source holder 320 is coupled to a motor frame 340 (FIG. 11) with a fastener (not shown) received in apertures 344 of the attachment flanges 332. The attachment flanges 332 extend laterally outward from side edges 348 of the tray 324 and include the apertures 344 for coupling the light source holder 320 to a motor frame 340. The fastener may be a screw, nail, clip or similar fastening means. In another embodiment, the light source holder 320 is coupled to either the upper housing portion 304 or the lower housing portion 308. The light source holder 320 is positioned so that the forward edge 328 and the light sources 22 are located proximate the opening 316 of the upper housing portion 304.

In the illustrated embodiment, the tray 324 of the light source holder 320 supports the light sources 22 and a circuit board 352 of the hair clipper 300 (e.g., a circuit board of the type shown in FIGS. 6 and 7). It should be readily apparent to those of skill in the art that the tray 324 may support other components of the hair clipper 300 as well.

FIGS. 13-15 illustrate another embodiment of a hair clipper 400. Like elements of the hair clipper 10 shown in FIG. 1 are identified by the same reference numerals. The hair clipper 400 includes the upper housing portion 14, the drive cap 26, and the lower housing portion 50, which all define the inner cavity 38 for substantially housing and surrounding various clipper components. The hair clipper 400 includes fiber optic wires that operate as the light sources for the clipper 400, whereby the wires are gathered in fiber optic bundles 404 and free ends of the fiber optic wires are supported by a light source holder 408.

The drive cap is removably coupled to the upper housing portion 14 to allow easy access to the inner cavity 38 of the hair clipper 400. The upper housing portion 14 and the drive cap 26 define the shroud 74 having the opening 78 for communicating with the opening 38. A first portion of the shroud 74A is formed by the upper housing portion 14, and a second portion of the shroud 74B is formed by the drive cap 26. The opening is positioned on the drive cap portion of the shroud 74B and opens towards the cutting end, thereby allowing light from the light source holder 408 to pass through the opening and towards the blade assembly 58. In another embodiment, the upper housing portion 14 may comprise a one-piece portion where the drive cap 26 is integral with or formed from a single piece of the upper housing portion 14.

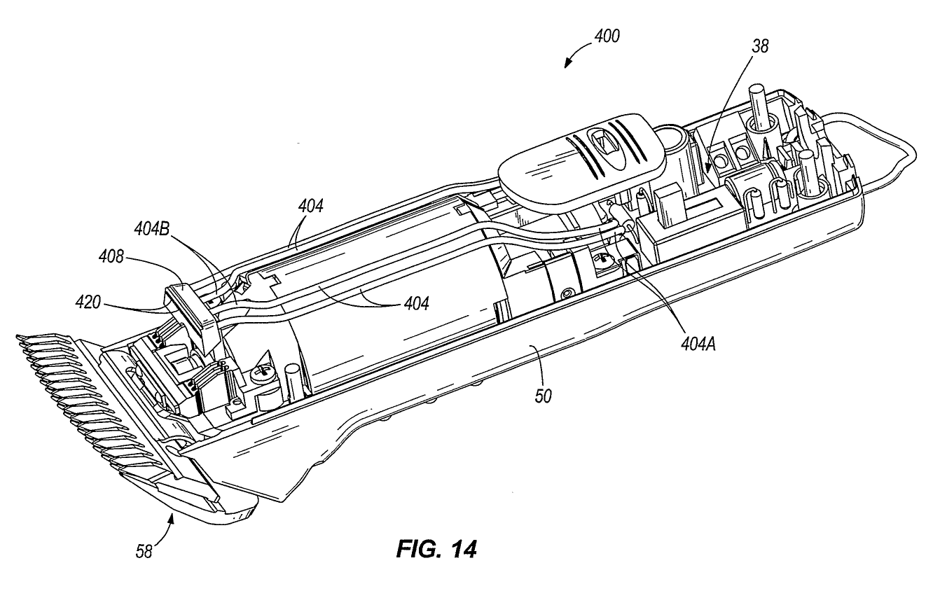

The light source holder 408 is substantially housed in the drive cap 26 and positioned within the inner cavity 38 proximate the opening 78. Referring to FIGS. 14-16, the light source holder 408 includes a body portion 412 and a mounting portion 416 extending substantially perpendicular to the body portion 412. Four apertures 420 are formed in the body portion 412 for receiving fiber optic bundles 404. Each aperture 420 slidingly receives one of the fiber optic bundles 404, although in a further embodiment, the apertures 420 may receive the bundles 404 through a screw motion and the like. In the illustrated embodiment, the light source holder 408 is coupled to the upper housing portion 14 (FIG. 14) with a fastener (not shown) received in a fastening aperture 432 formed in the mounting portion 416. The fastener may be a screw, nail, clip or similar fastening apparatus. The fastener aperture 432 receives the fastener to couple the light source holder 408 to the upper housing portion 14. In some embodiments, the light source holder 408 may be coupled to the drive cap 26. In the illustrated embodiment, the apertures 420 are rectangular, but in a further embodiment, the apertures 420 may be other shapes, for example, circular or square. Further, the light source holder 408 may include fewer or more apertures 420 corresponding to the number of fiber optic bundles 404.

In the illustrated embodiment, the light sources 22 are fiber optic wires that emit a white light, although any number of light colors may be used. The fiber optic wires are gathered in bundles 404 with each bundle including a first end 404A and a second, free end 404B. In a further embodiment, the bundles 404 of wires extending through the inner cavity 38 are housed within a tube or other support member. The first end 404A of each bundle 404 is positioned in a rear portion of the inner cavity 38 proximate the circuit board 46. Each bundle 404 is coupled to an LED 436, or other light source, at the first end 404A. In the illustrated embodiment, the bundle 404 is coupled to the LED 436 by a shrink tube 440 such that all the light emitted by LED is transmitted through the associated fiber optic wires. In the illustrated embodiment, the LEDs 436 are electrically coupled to the circuit board 46. The free end 404B of each bundle is positioned within one of the apertures 420 of the light source holder 408. The fiber optic wires are fanned out within the respective aperture 420 to emit light from the hair clipper 400.

The apertures 420 direct the fiber optic wires toward the opening 78 at the cutting end 34 of the housing 30 and are further positioned within the drive cap 26 to direct light through the opening 78 in the drive cap 26. The light from the fiber optic wires is directed to the blade assembly 58 to illuminate the hair being cut, the blade assembly 58, and work area adjacent to the hair being cut. The fiber optic wires spread the illuminate area over a larger area than other light sources, such as light bulbs or LEDs. In the illustrated embodiment, the apertures 420 in the light source holder 408 are in a linear arrangement, although in a further embodiment, the apertures 420 may be in a non-linear arrangement, wherein one aperture 420 may be in a more forward position than an adjacent aperture 420. The apertures 420 may also be at various angles within the light source holder 408 such that the fiber optic wires are directed at various angles. The linearity, angularity and numerical arrangement of the apertures 420 may be based on the hair clipping application for which the hair clipper 400 is utilized. In another embodiment, the free ends of the bundles may be housed in apertures or tubes having other shapes or colors.

It should be readily apparent to those of skill in the art that the fiber optic bundles 404 may be run to other locations within the hair clipper 400 to illuminate other components and areas surrounding the hair clipper 400.

In a further embodiment of the hair clippers discussed above, the light sources 22 may be moved by an operator to direct the light to a specific area.

Other embodiments of the present invention may utilize combinations of the above embodiments. The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

What is claimed is:

1. A hair clipper comprising:
a housing defining a cavity and including an opening communicating with the cavity;
a blade assembly coupled to a cutting end of the housing;
a holder positioned within the cavity and proximate the opening; and
a plurality of light sources, each light source received by the holder, the light sources positioned to direct light through the opening and towards the cutting end of the housing.

2. The hair clipper according to claim 1 wherein the housing portion includes a plurality of apertures formed therein for receiving the plurality of light sources, the apertures defining the opening.

3. The hair clipper according to claim 2 wherein the holder includes at least one fastening bracket for receiving at least one of the plurality of the light sources.

4. The hair clipper according to claim 1 wherein the housing includes an upper housing portion having a shroud portion that defines the opening and the opening faces the cutting end.

5. The hair clipper according to claim 1 wherein the holder is coupled to the upper housing portion and positioned proximate the opening.

6. The hair clipper according to claim 1 wherein the holder includes a plurality of apertures formed therein for receiving the plurality of light sources.

7. The hair clipper according to claim 1 wherein the holder includes a tray for supporting the light sources and an edge of the tray has a plurality of apertures, each aperture for receiving one light source.

8. The hair clipper according to claim 1 wherein the housing includes a drive cap positioned adjacent the cutting end, the drive cap defining the opening.

9. The hair clipper according to claim 1, and further comprising a lens positioned within the opening to cover the opening.

10. The hair clipper according to claim 1, and further comprising a constant current, soft start, voltage limited circuit board, wherein the circuit board is electrically coupled to a power source and the light sources.

11. The hair clipper according to claim 1 wherein a protective means is coupled to a portion of the light sources to anchor the light sources relative to the holder.

12. The hair clipper according to claim 1 wherein the plurality of light sources includes light emitting diodes.

13. The hair clipper according to claim 1 wherein the plurality of lights sources includes fiber optic wires.

14. A hair clipper comprising:
a housing defining a cavity and having a cutting end;
a drive cap coupled to the housing adjacent the cutting end, the drive cap further defining the cavity and including an opening communicating with the cavity;
a blade assembly coupled to the cutting end of the housing;
a holder positioned within the cavity and proximate the opening; and
a plurality of light sources, each light source received by the holder, the lights sources positioned to direct light through the opening and towards the cutting end of the housing.

15. The hair clipper according to claim 14 wherein the housing includes an upper housing portion and a lower housing portion.

16. The hair clipper according to claim 15 wherein the upper housing portion and the drive cap define a shroud portion including the opening, and wherein the opening faces the cutting end.

17. The hair clipper according to claim 15 wherein the holder is coupled to the upper housing portion and proximate the opening.

18. The hair clipper according to claim 14, wherein the holder includes a plurality of apertures formed therein for receiving the plurality of light sources.

19. The hair clipper according to claim 18 wherein the holder includes a tray having a forward edge, the plurality of apertures formed in the forward edge of the tray.

20. The hair clipper according to claim 14, and further comprising a lens positioned within the opening to cover the opening.

21. The hair clipper according to claim 14, and further comprising a constant current, soft start, voltage limited circuit board, wherein the circuit board is electrically coupled to a power source and the light sources.

22. The hair clipper according to claim 14 wherein a protective means is coupled to a portion of the light sources to anchor the light sources relative to the holder.

23. The hair clipper according to claim 14 wherein the plurality of light sources includes light emitting diodes.

24. The hair clipper according to claim 14 wherein the plurality of lights sources includes fiber optic wires.

25. A hair clipper comprising:
a housing having a lower portion and an upper portion, the housing defining a cavity and the upper portion including an opening communicating with the cavity;
a blade assembly coupled to a cutting end of the housing;
a holder positioned within the cavity and proximate the opening; and
a plurality of light sources, each light source received by the holder, the lights sources positioned to direct light through the opening and towards the cutting end of the housing; and
a circuit board to electrically couple a power source and the light sources.

26. The hair clipper according to claim 25 wherein the holder includes a plurality of apertures formed therein for receiving the plurality of light sources.

27. The hair clipper according to claim 25 wherein the holder is coupled to the upper housing portion and positioned proximate the opening.

28. The hair clipper according to claim 25 wherein the holder includes at least one fastening bracket.

29. The hair clipper according to claim 25 wherein the holder includes a tray for supporting the light sources and the circuit board.

30. The hair clipper according to claim 29 wherein a forward edge of the holder includes a plurality of apertures formed therein for receiving the plurality of light sources.

31. The hair clipper according to claim 25 wherein the housing includes a drive cap positioned adjacent the cutting end, the drive cap removably coupled to the housing and defining the opening.

32. The hair clipper according to claim 25, wherein the circuit board further comprises a constant current, soft start, voltage limited circuit board.

33. The hair clipper according to claim 25 wherein the plurality of light sources includes light emitting diodes.

34. The hair clipper according to claim 25 wherein the plurality of lights sources includes fiber optic wires.
